(19) United States
(12) Patent Application Publication
(10) Pub. No.: US 2024/0346535 A1
(43) Pub. Date: Oct. 17, 2024

(54) CORRELATING TELEMETRY DATA AND SURVEY DATA

(71) Applicant: Hewlett-Packard Development Company, L.P., Spring, TX (US)

(72) Inventors: Anton Wiranata, Boise, ID (US); Nathaniel Whitlock, Vancouver, WA (US)

(21) Appl. No.: 18/682,910

(22) PCT Filed: Aug. 31, 2021
(86) PCT No.: PCT/US2021/048460

§ 371 Date: Feb. 10, 2024

(51) Int. Cl. G06Q 30/0203

(52) U.S. Cl. CPC G06Q 30/0203

(57) ABSTRACT

A method, comprising receiving telemetry data from a plurality of computing devices, the telemetry data obtained during setup of the plurality of computing devices. The method also includes receiving survey data pertaining to a subpart of the plurality of computing devices, the survey data obtained during setup of the plurality of computing devices, and correlating the received telemetry data with the received survey data. The method further includes extrapolating survey data for a remainder of the plurality of computing devices based on the correlation between the received telemetry data and the received survey data.

### BACKGROUND

Enterprise data sources use different types of communication systems to connect with end users, such as consumers. For example, some enterprise data sources rely on electronic mail (email), telephone, etc., to communicate with consumers, who in turn can respond to the enterprise data sources. The quality of the user experience afforded to the user during an interaction between the user and the user support representative involves identifying if an interaction is associated with a positive sentiment or a negative sentiment.

### BRIEF DESCRIPTION OF THE DRAWINGS

FIG. 1 illustrates an example method for correlating telemetry data and survey data, in accordance with the present disclosure.

FIG. 2 illustrates an example apparatus for correlating telemetry data and survey data, in accordance with the present disclosure.

FIG. 3 illustrates an example apparatus for correlating telemetry data and survey data, in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In survey research, the survey response rate is the number of people who answered the survey divided by the number of people that the survey was sent to, and multiplied by 100. To assess the success of satisfaction of new users, or users that are using a new product and/or service, users may receive a setup or implementation survey. Depending on volume, setup or implementation surveys can be collected and analyzed weekly, monthly, quarterly, or semi-annually. Often, a fraction of users respond to surveys. For instance, roughly 7-10% of users who are sent surveys may respond. With such a small portion of the users responding to surveys, it may be difficult to accurately capture user sentiment and derive information to improve products and/or processes.

Accurately predicting survey responses for those users who did not reply to a survey could prove to be an incredibly useful tool and further expand the ability to consider the voice of the user while making business decisions and driving innovation. Correlating telemetry data and survey data, in accordance with the present disclosure, combines survey responses with telemetry data aspects related to setup of a computing device. By correlating the telemetry data and survey data, a predictive model may be created. The creation of a predictive model to infer how a user would have responded if they had provided a survey response, may allow for expanded sampling capabilities through a cost-effective automated methodology.

A method of correlating telemetry data and survey data, in accordance with the present disclosure, includes receiving telemetry data from a plurality of computing devices, the telemetry data obtained during setup of the plurality of computing devices. The method also includes receiving survey data pertaining to a subpart of the plurality of computing devices, the survey data obtained during setup of the plurality of computing devices, and correlating the received telemetry data with the received survey data. The method further includes extrapolating survey data for a remainder of the plurality of computing devices based on the correlation between the received telemetry data and the received survey data.

An apparatus for correlating telemetry data and survey data, in accordance with the present disclosure includes a non-transitory computer-readable storage medium comprising instructions. The instructions, when executed, cause a computing device to receive telemetry data from a plurality of computing devices, the telemetry data obtained during a setup process of the plurality of computing devices. The instructions also cause the computing device to receive survey data pertaining to a subpart of the plurality of computing devices, the survey data obtained during the setup process of the plurality of computing devices. The instructions also cause the computing device to create a predictive model to infer if a user associated with one of the plurality of computing devices is a promoter, passive, or detractor, by correlating the received telemetry data and the received survey data.

An apparatus for correlating telemetry data and survey data, in accordance with the present disclosure includes a non-transitory computer-readable storage medium comprising instructions. The instructions, when executed, cause a computing device to receive survey data from a subpart of a plurality of computing devices setup on a network hosted by the computing device. The instructions also cause the computing device to receive from the plurality of computing devices setup on the network, telemetry data associated with setup. The instructions also cause the computing device to correlate the telemetry data and the survey data, and generate a net promotor score for the plurality of computing devices based on the correlation of the telemetry data and the survey data.

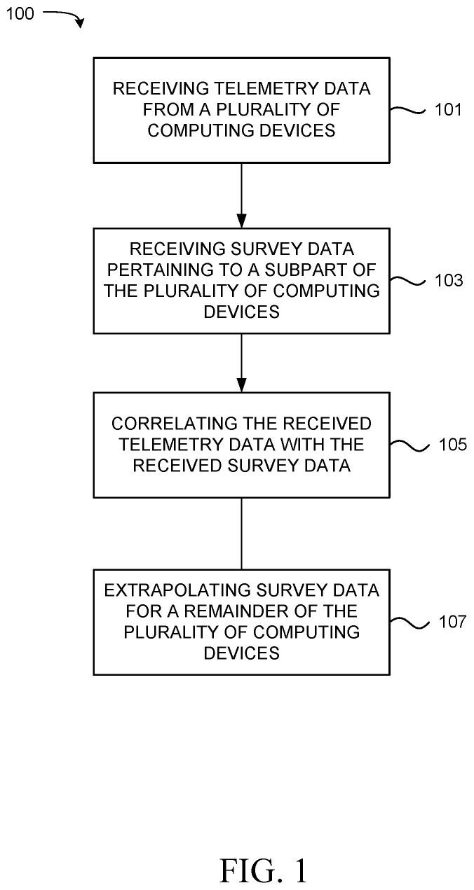

Turning now to the figures, FIG. 1 illustrates an example method 100 for correlating telemetry data and survey data, in accordance with the present disclosure. As illustrated, the method 100 includes receiving telemetry data from a plurality of computing devices, the telemetry data obtained during setup of the plurality of computing devices at 101. Some example methods may provide cloud print platforms that provide services to enable the computing device to register to a cloud, help the cloud to connect to the cloud services, and ensure connectivity of the cloud services with the computing devices. The cloud services may establish trust with help of security solutions. A trust may be established between a computing device and a cloud platform. Accordingly, a plurality of computing devices may setup and register with a cloud service as part of setup of the computing device. During the setup process, telemetry data may be collected which pertains to the setup of the computing devices. As used herein, telemetry data refers to or includes data collected by each respective computing device during the setup process and automatically transmitted to the cloud service. Non-limiting examples of telemetry data collected include the time it took users to traverse the setup process, the number of attempts through the setup process, how many times items were shown to the user, and information regarding the types and/or frequency of errors encountered during the setup process. Examples are not so limited, and additional and/or different features of telemetry data may be obtained during the setup process.

At 103, the method 100 includes receiving survey data pertaining to a subpart of the plurality of computing devices, the survey data obtained during setup of the plurality of computing devices. Survey data may relate to any aspect of the setup process and/or other aspects of user satisfaction. The survey data may be in the form of free text, numerical ratings, and/or categorical selections. Non-limiting examples of survey data that may be obtained includes questions relating to the overall experience during setup, the reason for the experience, the ease with which the user was able to setup the computing device, how clear the setup instructions were, what brand their previous computing device was/is, and what age the user is, among other survey questions.

At 105, the method 100 includes correlating the received telemetry data with the received survey data. In some examples, correlating the received telemetry data with the received survey data includes selecting a plurality of features from the telemetry data to correlate with the survey data. A serial number for the computing device may be used to correlate received survey data with telemetry data for a particular computing device. While the telemetry data may be in numerical format, and the survey data may be in many different formats, correlating the telemetry data with the survey data may include converting the survey data into numerical values. Examples are not so limited, and correlating the telemetry data with the survey data may include converting the received telemetry data and the received survey data into a common format. By correlating the survey data with the telemetry data, predictive models may be generated which allow for survey data to be predicted for a remainder of the computing devices that did not submit survey responses. For instance, if 10% of all users that setup computing devices responded to the survey, survey responses may be predicted for the remaining 90% of users that setup computing devices. In such a manner, each user that setup a computing device on the network may be identified as a promoter (a user that would generally promote the computing device and/or service setup on the network), a passive (a user that has a neutral opinion of the computing device and/or service setup on the network), or a detractor (a user that would not generally promote the computing device and/or service setup on the network) regardless of whether the user completed a survey or not.

At 107, the method 100 includes extrapolating survey data for a remainder of the plurality of computing devices based on the correlation between the received telemetry data and the received survey data. In some examples, extrapolating survey data includes determining which of a plurality of features of the telemetry data were associated with the user being classified as a promoter, a passive, or a detractor. In some examples, extrapolating survey data includes determining for each of a remainder of the plurality of computing devices, whether survey data would indicate a user of the respective computing device would be classified as a promoter, a passive, or a detractor. Accordingly, in some examples, the method 100 includes classifying users of each of the plurality of computing devices as a promoter, a passive, or a detractor based on the received survey data.

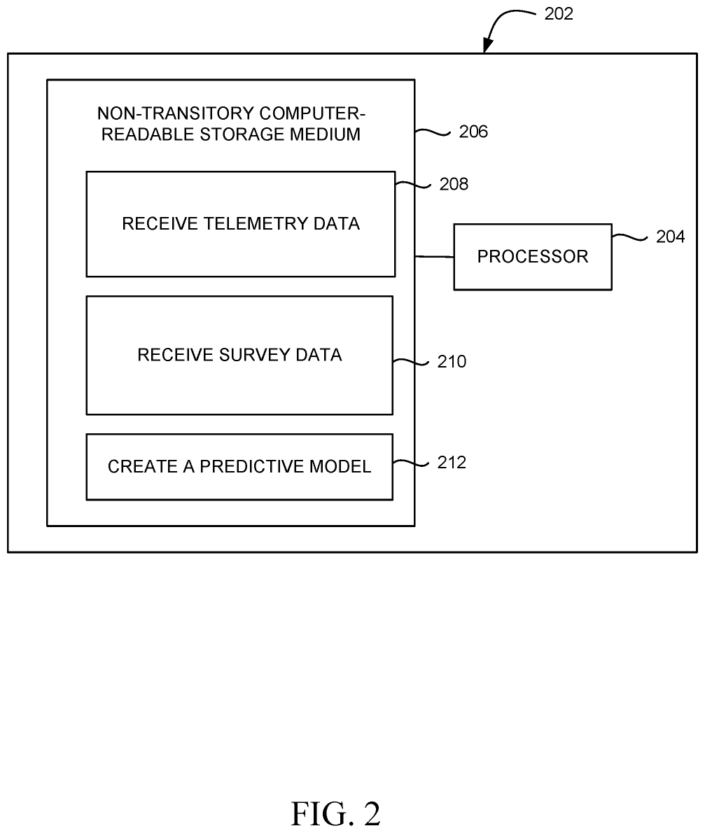

FIG. 2 illustrates an example computing device 202 for correlating telemetry data and survey data, in accordance with the present disclosure. As illustrated in FIG. 2, the computing device 202 may include a processor 204, and a computer-readable storage medium 206. The computing device 202 may perform the method 100 illustrated in FIG. 1.

The processor 204 may be a central processing unit (CPU), a semiconductor-based microprocessor, and/or other hardware device suitable to control operations of the computing device 202. Computer-readable storage medium 206 may be an electronic, magnetic, optical, or other physical storage device that contains or stores executable instructions. Thus, computer-readable storage medium 206 may be, for example, Random Access Memory (RAM), an Electrically Erasable Programmable Read-Only Memory (EEPROM), a storage device, an optical disc, etc. In some examples, the computer-readable storage medium 206 may be a non-transitory storage medium, where the term ‘non-transitory’ does not encompass transitory propagating signals. As described in detail below, the computer-readable storage medium 206 may be encoded with a series of executable instructions 208-212.

In some examples, computer-readable storage medium 206 includes instructions 208 that when executed, cause the computing device 202 to receive telemetry data from a plurality of computing devices, the telemetry data obtained during a setup process of the plurality of computing devices. During the setup process, telemetry data may be sent from the computing device to the network. This telemetry data can be used to describe the experience the user had during the setup process, and the survey results reflect those experiences from the eyes of the user. As described with regards to FIG. 1, telemetry data refers to or includes data collected by each respective computing device during the setup process and automatically transmitted to the cloud service. The telemetry data may be collected locally by computing device 202 and/or externally by a remote computing device.

The computer-readable storage medium 206 may also include instructions 210 that when executed, cause the computing device 202 to receive survey data pertaining to a subpart of the plurality of computing devices, the survey data obtained during the setup process of the plurality of computing devices. Once the user reaches a specific step in the setup process and creates an account, a registration survey may be sent via email. Also as described with regards to FIG. 1, survey data may relate to any aspect of the setup process and/or other aspects of user satisfaction. The survey data may be collected locally by the computing device 202 and/or externally by a remote computing device.

The computer-readable storage medium 206 may also include instructions 212 that when executed, cause the computing device 202 to create a predictive model to infer if a user associated with one of the plurality of computing devices is a promoter, passive, or detractor, by correlating the received telemetry data and the received survey data. As used herein, a predictive model refers to or includes an algorithm that may predict future behavior based on historical data. Non-limiting examples of predictive models that may be used include logistic regression, random forest, catboost, or combinations thereof. This capability may enable the ability to understand the main drivers of why users become promoters, passives or detractors and highlight the parts of the setup process which may be improved to produce improved user experiences. Using logistic regression, features may be identified in terms of the contribution to a user being a promoter. For instance, the time taken between making a decision on a program offer and completing an account creation may be determined to be a strong predictor of a user being a promotor.

In some examples, computer-readable storage medium 206 may include instructions that when executed, cause the computing device 202 to determine which of a plurality of features of the telemetry data have a greatest association with positive survey data as compared to a remainder of the plurality of features of the telemetry data. That is, using the collected data from the plurality of computing devices, the computing device 202 may identify which feature of the telemetry data most strongly predicted whether the user was a promoter, a passive, or a detractor. As used herein, a feature of the telemetry data refers to or includes a metric that was collected during the setup process. For instance, time between one step of the setup process and a second step of the setup process may be a feature of the telemetry data, whereas a number of times setup instructions were referenced may be another feature of the telemetry data. For instance, the time between making a decision on a program offer and creating an account may be an important feature to drive predictive performance. As another example, the time between being provided an offer and completing enrollment in the offer may also be a strong predictor. Additionally, input variables may contribute to identifying detractors. For instance, the time between clicking data privacy notice information and making a decision on a program offer may be a predictor of a detractor.

In some examples, computer-readable storage medium 206 may include instructions that when executed, cause the computing device 202 to compute a relative score demonstrating the importance of one feature of the telemetry data relative to other features in terms of ability to impact the overall user experience. As such, the computer-readable storage medium 206 may include instructions that when executed, cause the computing device 202 to determine which features of setup contribute the most to the user being a detractor.

In some examples, computer-readable storage medium 206 may include instructions that when executed, cause the computing device 202 to identify an aspect of the setup process to modify based on the predictive model.

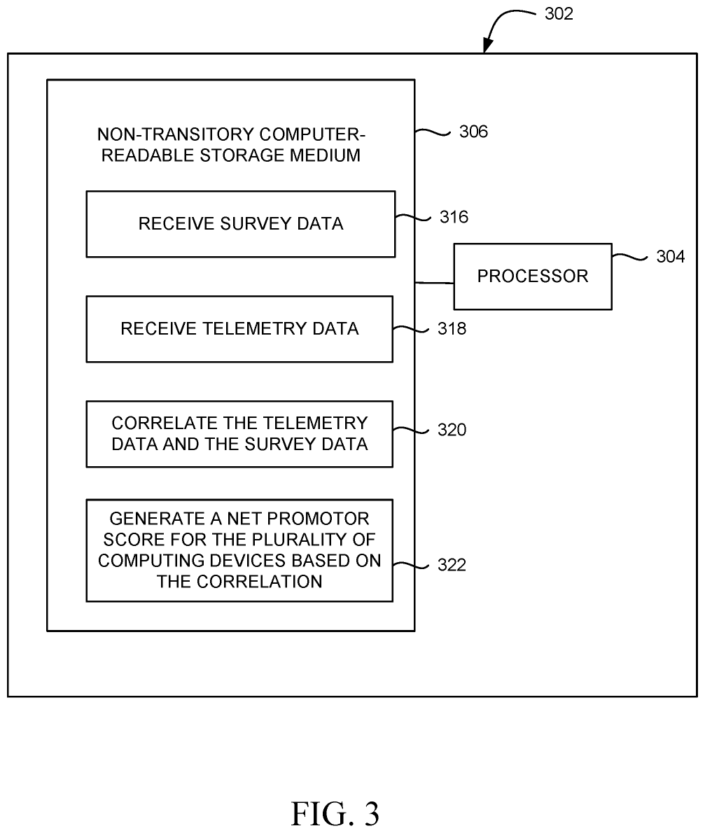

FIG. 3 illustrates an example computing device 302 for correlating telemetry data and survey data, in accordance with the present disclosure. In general, the computing device 302 shown in FIG. 3 may include various components that are the same and/or substantially similar to the computing device 202 shown in FIG. 2, which was described in greater detail above. As such, for brevity and ease of description, various details relating to certain components in the computing device 302 shown in FIG. 3 may be omitted herein to the extent that the same or similar details have already been provided above in relation to the computing device 202 illustrated in FIG. 2.

As illustrated in FIG. 3, the computing device 302 may include a processor 304, and a computer-readable storage medium 306. The computer-readable storage medium 306 may be encoded with a series of executable instructions 316-322. They computer-readable storage medium 306 may include instructions 316 that when executed cause the computing device 302 to receive survey data from a subpart of a plurality of computing devices setup on a network hosted by the computing device. In some examples, the computing device 302 may be a computing device remote to the computing device being setup on the network. As such, the computing device 302 may receive the survey data over a network connection, such as may be implemented in a cloud-based solution.

The computer-readable storage medium 306 may include instructions 318 that when executed cause the computing device 302 to receive from the plurality of computing devices setup on the network, telemetry data associated with setup. As discussed herein, telemetry data may be collected locally by the computing device being setup on the network, and/or telemetry data may be collected remotely.

The computer-readable storage medium 306 may include instructions 320 that when executed cause the computing device 302 to correlate the telemetry data and the survey data. In some examples, the instructions 320 to correlate the telemetry data and the survey data include instructions to correlate the telemetry data and the survey data using a serial number for the respective computing device. As described with regards to FIG. 1, the telemetry data and the survey data may be correlated by converting the telemetry data and the survey data into a common format. Correlation may include converting survey data to numerical format from text and/or categorical format. Correlation of the telemetry data with the survey data may be performed by the computing device being setup on the network or by a remote computing device, such as may be implemented in a cloud-based solution.

The computer-readable storage medium 306 may include instructions 322 that when executed cause the computing device 302 to generate a net promotor score for the plurality of computing devices based on the correlation of the telemetry data and the survey data. As used herein, a net promoter score (NPS) refers to or includes a metric that takes the form of a single survey question asking respondents to rate the likelihood that they would recommend a company, product, or a service to a friend or colleague. The NPS assumes a subdivision of respondents into “promoters” who provide ratings of 9 or 10, “passives” who provide ratings of 7 or 8, and “detractors” who provide ratings of 6 or lower. Usually, users of the NPS perform a calculation that involves subtracting the proportion of detractors from the proportion of promoters collected by the survey item, and the result of the calculation is typically expressed as an integer rather than a percentage.

In some examples, the computer-readable storage medium 306 may include instructions that when executed cause the computing device 302 to classify each computing device among the subpart of the plurality of computing devices as a promoter, a passive, or a detractor. As data is collected from the computing devices, the classification is a classification of the user of each computing device as a promoter, a passive, or a detractor. Moreover, using predictive modeling, as described herein, the survey data may be extrapolated to users that did not complete a survey. As such, the computer-readable storage medium 306 may include instructions that when executed cause the computing device 302 to classify each of a remainder of the plurality of computing devices as a promoter, a passive, or a detractor based on data for the identified features.

In some examples, the computer-readable storage medium 306 may include instructions that when executed cause the computing device 302 to identify a plurality of features of the telemetry data that influenced the classification for each of the each computing device among the subpart of the plurality of computing devices.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
receiving telemetry data from a plurality of computing devices, the telemetry data obtained during setup of the plurality of computing devices;
receiving survey data pertaining to a subpart of the plurality of computing devices, the survey data obtained during setup of the plurality of computing devices;
correlating the received telemetry data with the received survey data; and
extrapolating survey data for a remainder of the plurality of computing devices based on the correlation between the received telemetry data and the received survey data.

2. The method of claim 1, wherein correlating the received telemetry data with the received survey data includes selecting a plurality of features from the telemetry data to correlate with the survey data.

3. The method of claim 1, further including classifying users of each of the plurality of computing devices as a promoter, a passive, or a detractor based on the received survey data.

4. The method of claim 3, wherein extrapolating survey data includes determining which of a plurality of features of the telemetry data were associated with the user being classified as a promoter, a passive, or a detractor.

5. The method of claim 1, wherein extrapolating survey data includes determining for each of a remainder of the plurality of computing devices, whether survey data would indicate a user of the respective computing device would be classified as a promoter, a passive, or a detractor.

6. A non-transitory computer-readable storage medium comprising instructions that when executed cause a computing device to:
receive telemetry data from a plurality of computing devices, the telemetry data obtained during a setup process of the plurality of computing devices;
receive survey data pertaining to a subpart of the plurality of computing devices, the survey data obtained during the setup process of the plurality of computing devices; and
create a predictive model to infer if a user associated with one of the plurality of computing devices is a promoter, passive, or detractor, by correlating the received telemetry data and the received survey data.

7. The medium of claim 6, including instructions that when executed, cause the computing device to determine which of a plurality of features of the telemetry data have a greatest association with positive survey data as compared to a remainder of the plurality of features of the telemetry data.

8. The medium of claim 6, including instructions that when executed, cause the computing device to determine which features of setup contribute the most to the user being a detractor.

9. The medium of claim 8, including instructions that when executed, cause the computing device to identify an aspect of the setup process to modify based on the predictive model.

10. The medium of claim 6, wherein the predictive model includes logistic regression, random forest, or catboost, or combinations thereof.

11. A non-transitory computer-readable storage medium comprising instructions that when executed cause a computing device to:
receive survey data from a subpart of a plurality of computing devices setup on a network hosted by the computing device;
receive from the plurality of computing devices setup on the network, telemetry data associated with setup;
correlate the telemetry data and the survey data; and
generate a net promotor score for the plurality of computing devices based on the correlation of the telemetry data and the survey data.

12. The medium of claim 11, wherein the instructions to correlate the telemetry data and the survey data include instructions to correlate the telemetry data and the survey data using a serial number for the respective computing device.

13. The medium of claim 11, including instructions that when executed cause the computing device to classify each computing device among the subpart of the plurality of computing devices as a promoter, a passive, or a detractor.

14. The medium of claim 13, including instructions that when executed cause the computing device to identify a plurality of features of the telemetry data that influenced the classification for each of the each computing device among the subpart of the plurality of computing devices.

15. The medium of claim 14, including instructions that when executed cause the computing device to classify each of a remainder of the plurality of computing devices as a promoter, a passive, or a detractor based on data for the identified features.
